(19) United States
(12) Patent Application Publication
(10) Pub. No.: US 2021/0324685 A1
(43) Pub. Date: Oct. 21, 2021

(54) INTERLOCKING TUBULAR WITH SECTIONED PARTS AND RELATED METHOD

(71) Applicant: Chad Rudolph, Versailles, KY (US)

(72) Inventor: Chad Rudolph, Versailles, KY (US)

(21) Appl. No.: 17/230,589

(22) Filed: Apr. 14, 2021

Related U.S. Application Data
(60) Provisional application No. 63/011,500, filed on Apr. 17, 2020.
(60) Provisional application No. 63/040,058, filed on Jun. 17, 2020.
(60) Provisional application No. 63/119,036, filed on Nov. 30, 2020.

(51) Int. Cl. E21B 17/046; E21B 7/20; E21B 43/10; F16L 21/08; F16L 21/06

(52) U.S. Cl. CPC E21B 17/0465; E21B 7/208; F16L 21/06; F16L 21/08; E21B 43/10

(57) ABSTRACT

An interlocking independent tubular with multiple circumferential sections allows a borehole to advance by encasing with a single pass, the structurally independent tubular. The independent tubular is single layered, having a major arc and a minor arc forming circumferential sections. The minor arc may be defined by less than 180 degrees, and the major arc may be a circumferential section defined by greater than 180 degrees. The major arc and minor arc align longitudinally to form the independent tubular. Installation may involve partially radially collapsing the major arc, inserting the major arc and minor arc through a previously installed tubular, reexpanding the major arc and connecting the major arc and minor arc to form the independent tubular downhole from the previously installed tubular, and joining the independent tubular to the previously installed tubular. The tubes may be joined by interlocking female and male ends of the tubes.

This application claims priority to U.S. PROVISIONAL Patent Application Ser. No. 63/011,500, filed Apr. 17, 2020, and to U.S. PROVISIONAL Patent Application Ser. No. 63/040,058, filed Jun. 17, 2020, and to U.S. PROVISIONAL Patent Application Ser. No. 63/119,036, filed Nov. 30, 2020, the disclosures of which are incorporated herein by reference.

### TECHNICAL FIELD

This invention generally relates to a structurally independent interlocking tubular with sectioned parts adapted to collapse and install within and borehole, including through an already-installed tubular, sequentially providing encasement through a borehole as a bottomhole is advanced, thereby advancing a section of pipe within the borehole.

### BACKGROUND OF THE INVENTION

Boreholes are generally formed and advanced by using mechanical drilling equipment have a rotating drilling tool, a pneumatic drilling tool, or a water jet cutter, e.g., a bit, a pneumatic bit, or a water jet accordingly. For example, and in general, when creating a borehole in the earth, a drilling bit is extending to and into the earth and rotated or activated to create a hole in the earth. In general, to perform the drilling operation the bit must be forced against the material to be removed with enough force to exceed the shear strength, compressive strength or combinations thereof, of that material. Thus, in conventional drilling activity mechanical forces exceeding these strengths of the rock or earth must be applied. The material that is cut from the earth is generally known as cuttings, e.g., waste, spoils, which may be chips of rock, dust, rock fibers, soils and other types of materials and structures that may be created by the bit's interactions with the earth. These cuttings are typically removed from the borehole using augers, conveyors, muck carts, vacuum lines, fluids, or other means known to the art.

Tubes are generally installed and advanced by using a mechanical force to thrust or pull both the entire string of product pipe and mechanical drilling bit concurrently or independently. There is a need to reduce the risk associated with tunneling projects and provide an alternate design, process, and method to serve this purpose. There is a need to build a tunnel as it advances further along the borehole, in independent sections and being interlocking and wholly structural, without thrusting or pulling a continuous string of tubes across the length of the borehole, with a tubular that may serve as the final product pipe, encases the length of the borehole, and is structurally sound. There is a need to improve steering capabilities, increase installation lengths of boreholes, reduce lubrication quantities, better manage weight on bit (WOB), being the amount of pressure applied onto the cutterhead against the bottomhole to strike the bottomhole and remove material to advance a borehole, and reduce thrust requirements.

This invention serves to improve these purposes compared to conventional technologies and methods. As a borehole is advanced farther and farther, the ability to control ground friction, provide proper lubrication, control steering, and maintain product integrity becomes more difficult. In general, to thrust in place a string of tubes across the length of a borehole, jacking frames thrust tubes from a stationary location or bore pit, utilizing large jacking forces, specially designed thrust blocks to counter any forces anticipated, all the while maintaining tubular integrity and tubular joint integrity not exceeding its design manufacturing limits. In general, to pull in place a string of tubes across the length of a borehole, pulling devices must attach to the leading tube, nearest the face of the borehole, and continuously pull the tubes from the entry point of the borehole to its exit location. Both methods require more thrust or pulling forces, more lubrication quantities, and more WOB management than this present invention.

As used herein, unless specified otherwise “jacking frame” should be given its broadest possible meaning, and includes, the structure within which the mechanical drilling device is supported for operation and may provide thrust to the mechanical drilling device for correct weight on bit (WOB) and advancement. This may include a structure that utilizes hydraulic cylinders as a means to extend/retract the structure against the interlocking tubular. This may include a structure of solid design matching the shape and similar size to the outer interlocking tubular being installed through the borehole, e.g. round steel casing pipe, such as the jacking frame shall provide extension/retraction movement against the interlocking tubular, and must withstand and operate under given soil loads above. This may include a structure consisting of an open framework that supports the thrust load applied to advance the borehole and rigid enough to maintain the mechanical drilling device to strike the bottomhole; it is conceived the interlocking tubular and tubular jacking frame may have a rectangular, square, circular, oval, trapezoidal, arch type shape that matches the size and shape of the outer interlocking tubular which the jacking frame advances, and may be any shape and configuration known in the arts and conceived of in the future, without departing from the spirit of the inventions.

As used herein the term “earth” should be given its broadest possible meaning, and includes, the ground, all-natural materials, such as rocks, and artificial materials, such as concrete, that are or may be found in the ground, including without limitation rock layer formations, such as, granite, basalt, sandstone, dolomite, sand, salt, limestone, rhyolite, quartzite, shale rock, displaceable soil, frozen water and frozen materials.

As used herein, unless specified otherwise, the term “borehole,” “bore path,” “tunnel,” “shaft,” “drilled borehole,” should be given its broadest possible meaning and includes any opening that is created in a material, a work piece, a surface, the earth, a structure (e.g., building, protected military installation, nuclear plant, offshore platform, or ship), or in a structure in the ground, (e.g., foundation, roadway, airstrip, cave or subterranean structure) that is substantially longer than it is wide. For example, this may include a 6 feet diameter borehole that is 100 feet long, an 8 feet diameter borehole that is 1,000 feet long, a 5 feet diameter borehole that is 10,000 feet long, and conceivably larger diameters of boreholes and longer lengths, such as a well, a well bore, a micro tunnel installation, a bore and jack installation, a hand mine tunnel liner plate installation, an unencased bore, a horizontal directional drill installation and other terms commonly used or known in the arts to define these types of narrow long passages. Wells and boreholes may further include exploratory, productions, abandoned, deteriorated, and collapsed wells and boreholes.

Boreholes for use in horizontal boring are generally oriented substantially horizontal, they may also be oriented on an angle from horizontal, to and including vertical. Thus, using a horizontal line, based upon a level as a reference point, a borehole can have orientation ranging from 0 degrees i.e., horizontal, to 90 degrees i.e., vertical and greater than 90 degrees or less than 0 degrees e.g., such as heel and toe and combinations of these such as for example “U” and “Y” shapes. Boreholes may further have segments or sections that have different orientations, they may have straight sections and arcuate section and combinations thereof; and for example, may be of the shapes commonly found when directionally drilling, curved microtunneling, and when cased bore and jack drilling is employed.

As used herein, unless specified otherwise, the term “vertical drilling,” “deep foundation,” “foundation drilling,” “micro piles,” “tripod piles,” “secant piled walls,” “marine piles,” “under reamed piles,” should be given its broadest possible meaning and includes any opening that is created in a material, a work piece, a surface, a structure, the earth (e.g., a body of water, sea shore, river, ocean, gulf, creek, or valley). Boreholes for use in vertical caisson, pier foundation drillings may be generally oriented substantially vertical; they may also be oriented on an angle from vertical, to and including horizontal. Thus, using a vertical line, based upon a level as a reference point, a borehole can have orientations ranging from 0 degrees i.e., vertical to 90 degrees, i.e., horizontal and greater than 90 degrees e.g., such as an angled micro pile or tripod pile. Boreholes may further have segments or sections that have different orientations, they may have straight section and arcuate sections and combinations thereof; and for example, may be of the shapes commonly found when vertical caisson drilling and pier foundation drilling is employed.

Thus, as used herein unless expressly provided otherwise, the “bottom” of a borehole, the “bottom surface” of the borehole, “bottomhole,” and similar terms refer to the end of the borehole, i.e., that portion of the borehole furthest along the path of the borehole from the borehole's opening, the surface of the earth, or the borehole's beginning. The terms “side” and “wall” of a borehole should be given their broadest possible meaning and include the longitudinal surfaces of the borehole, whether interlocking tubular or a liner is present, as such, these terms would include the sides of an open borehole or the sides of the interlocking tubular that has been positioned within a borehole. Boreholes may be made up of a single passage, multiple passages, connected passages and combinations thereof, in a situation where multiple boreholes are connected or interconnected each borehole would have a borehole bottom. Boreholes may be formed in the sea floor, under bodies of water, on land, in ice formation, or in other locations and settings.

Boreholes including an interlocking tubular installed therein, such that the tubular ultimately acts as an encasement for a tunnel, passageway, shaft, carrier pipe or is installed as the carrier pipe, generally advance the tubular product, by mechanically thrusting or pulling the tubular, while simultaneously utilizing a mechanical drill bit to excavate the earth to advance a borehole. The tubular has required thrust pressures for advancement and the mechanical drilling device may utilize a unique required weight on bit to properly excavate the earth materials. These two required forces may be unique. Cuttings are typically removed from the borehole by augers, conveyors, muck carts, vacuum lines, fluids, or other methods known to the art.

As used herein, unless specified otherwise, the terms “ream”, “reaming” a borehole, or similar such terms, should be given their broadest possible meaning and includes any activity performed on the sides of a borehole, such as, e.g., increasing the diameter of the borehole and removing materials from the sides of the borehole.

As used herein, unless specified otherwise, the terms “drill bit”, “bit”, “drilling bit”, “cutter head”, “tunnel bore machine”, “down the hole hammer bit face” or other similar such terms, should be given their broadest possible meaning and include all tools designed or intended to create a borehole in an object, a material, a work piece, a surface, the earth or a structure including structures within the earth or manmade, and would include bits used in the horizontal boring, pipe jacking, microtunneling, dirt and rock boring, equal pressure balance machines, hand-mine tunnels, vertical piling, vertical caisson drilling, vertical shaft drilling arts, such as fixed cutter, roller cone bits, disc cutters, down the hole hammer bits, water jet cutter assemblies, picks and shovels both manual and powered, high powered fiber lasers, as well as, other types of bits, such as reaming cones, air spades, sonic drill bits, and combinations and variations of these.

As used herein, unless specified otherwise, the terms “interlocking tubular with sectioned area, interlocking material”, “tubular material”, “tube”, or other similar terms, should be given their broadest possible meaning and include all tubular materials designed or intended to protect and encase a borehole in an object, a material, a work piece, a surface, the earth or a structure including structures within the earth or manmade, and would include such materials as steel, fiberglass, plastic, reinforced concrete pipe, HDPE, fiberglass reinforced resin polymer, clay jacking pipe, or other materials known in the arts suitable to be collapsible, hinged, or mechanically joined, slide within and through a previously installed tubular, then opened and interlocked by ends of both tubulars matching alignments, installed to a final position. As materials are used in the sliplining process, minimum thrust requirements may be placed on such materials and may be designed with these parameters without deviating from the spirit of this invention. This may include future materials to create a collapsible material in the spirit of this invention, and may be any shape and configuration known in the arts and conceived of in the future, without departing from the spirit of the inventions.

As used herein, unless specified otherwise, the terms “first section”, “sectioned part”, “sectioned part with interlocking ends”, or other similar terms should be given their broadest possible meaning and include an entire portion or section removed from an interlocking tubular. First sections may be removed from an original tube, being one part of the entire and original tube now being a minimum first section and second section. The first section may be designed to be reinstalled with the second section post expansion. A first section may be a minor arc having a less than 180 degrees arc. This may include first sections and second sections that may be any shape and configuration known in the arts, without departing from the spirit of the inventions.

As used herein, unless specified otherwise, the terms “second section”, interlocking tubular without sectioned part”, “collapsible tube”, or other similar terms, should be given their broadest possible meaning and include a portion of the tube remaining after the first section has been removed. Thus, the interlocking tubular may collapse to slide within and through another tube, being longitudinal in nature, having interlocking ends that provide and form a whole and structural connection when having its first section reinstalled into the collapsed interlocking tubular post expansion. The second section may be a major arc having a greater than 180 degrees arc. First sectioned parts may be removed from the original interlocking tube by means of cutting, torching, CNC machine cutting methods such as plasma torch, water jet torch, and high-powered fiber laser.

As used herein, unless specified otherwise, the terms “linear actuating device”, “hydraulic cylinder”, “mechanical ratcheting binders”, “two way cylinders”, or other similar terms, should be given their broadest possible meaning and include all devices manually or mechanically operated, designed to collapse and expand a second section as described further in accordance with the present invention.

As used herein, unless specified otherwise, the terms “interlocking tubular ends”, “ends”, “interlocking joints”, “bell and spigot”, “weldable ends”, “fusible ends”, “grooved ends”, “threaded ends”, “flanged ends”, or other similar terms, should be given their broadest possible meaning and include all tubular material connection processes and designs intended to create a tight fitting connection between two connecting ends of two tubulars when used with the present invention. The connection is intended to occur once the tube expands from its collapsed position into a final position of a correct radius or dimensional shape. This may include any combinations thereof, without departing from the spirit of the inventions.

As used herein, unless specified otherwise, the terms “interlocking end” or other similar terms, should be given their broadest possible meaning and include all interlocking tubular end pieces that include a profile, allowing a longitudinal gap to exist in a connection between two interlocking ends, such that as female and male interlocking ends are fully engaged to their defined radius or dimensional shape, there exists a longitudinal gap between the male profile and female profile. This longitudinal gap may be of a defined allowance. The longitudinal gap may allow for the ability to slide the interlocking tubulars apart or closer together in a longitudinal direction while maintaining the interlocking nature. The longitudinal gap may also allow deflection in a given joint, such as of a defined amount. A shim or welding method may be used to secure correct deflection as described later.

Such angled joints designs may provide deflection in a given joint without the use of a shim described above. In some instances, the joints may be of a straight line angle, a curved or radius angle, v-shaped angles, u-shaped angles, ball and socket designs, and inverse ball and socket designs. These designs are not limited to modifying each described angle as smooth surfaced, ridges or rolling ridges for interlocking purposes, combinations thereof, without departing from the spirit of the invention. Such designs for arcuate tunnels are used in curved micro tunnel installations, typically utilizing specialized shims between joints to create deflection at a determined point along the bore path. Currently, such designs are of particular risk to joint pressure point loading. This design overcomes such a risk inherent in curved tunneling where a radius exists in the alignment.

In general, fiberglass reinforced pipe, concrete reinforced pipe, steel casing, and other jacking pipe strings are pulled or pushed forward from one stationary launch pit or location until the tubular material is advanced through the length of the borehole to its termination. Such, each new section of tubular material advances the previously set section forward further into the borehole. Each new section becomes part of the overall length of the tubular material installed and continually advances through the borehole until its final position, at which point the entire borehole has been encased and protected.

In general, tunnel liner plate, lag and beam, rib and board installations do not advance along a borehole from a stationary launch pit. These types of installations occur near the borehole as the hand-mining, tunneling system or boring system advances further along the borehole, and new stationary sections of liners are installed between the tunneling system and the nearest installed tunnel liner plate section. These types of installations are typically temporary and may require grout filling between the carrier pipe and the liner following the installation of the carrier pipe.

As used herein, unless specified otherwise, the term “tube”, “tubular”, “interlocking tube”, should be given its broadest possible meaning and includes drill pipe, steel casing, concrete pipe, fiberglass reinforced pipe, steel wound pipe, concrete box culvert, clay jacking pipe, tunnel liner plate, production tubing and any similar structures having at least one channel therein that are, or could be used, in the boring, tunneling, micro tunneling, hand mining, micro piling, shaft construction, deep foundation drilling, marine piling, and vertical drilling industry.

As used herein, unless otherwise described, the term “joint” should be given its broadest possible meaning and includes all types of devices, systems, methods, structures and components used to connect tubulars together, such as for example, welded joints, interlocking joints, threaded pipe joints, bell and spigot gasket pipe joints, and bolted flanges. For drill pipe joints, the joint section typically has a smooth outer diameter (“OD”) wall. As used herein the thickness of the wall of tubulars is the thickness of the material between the internal diameter of the tubular and the external diameter of the tubular.

As used herein, unless specified otherwise “seal”, “waterproof seal”, “outer diameter gasket”, “rubber ring”, “watertight seal”, should be given its broadest possible meaning and includes butyl rubber rings, nylon materials, plastic, neoprene, nitrile rubber, EPDM, silicone, and any known materials in industry that seals the junction between two surfaces, such as between the outer diameter or outer perimeter of a tubular and an inner diameter or inner perimeter of a jacking frame, for express purposes of providing a leakproof or watertight protection from external soils, water, fluids, etc. from infiltrating past the exterior junction and into the inner tubular area. These types of seals are typically used in tunneling conditions that experience high water tables, are subject to high water table pressures, and where safety must be maintained from external fluids or soils from entering. Risk of loss of ground from above, flooded tunneling conditions, and providing a sealed environment are key purposes for a seal.

As used herein, unless specified otherwise “inside radius gauge”, “large radius gauge set”, “gauge set”, “protractor”, “trammel”, “beam trammel”, “laser measuring device”, and similar such terms are used in their broadest sense and would include measuring activities on the interlocking female end, for purposes of maintaining an accurate radius or dimensional shape during the installation of the interlocking tubular, and during the installation of the interlocking sectioned part. Such common tools are found in industry and provide precision measurement for accurate tubular placement consistent with this present invention, without departing from the spirit of the invention.

As used herein, unless specified otherwise “bore and jack,” “horizontal boring,” “tunneling,” “vertical drilling,” “horizontal directional drilling,” and “caisson drilling,” “foundation drilling,” “deep foundation drilling,” “drilled shafts,” “low headroom drilling,” and similar such terms are used in their broadest sense and would include drilling activities on, or in, any body of water, whether fresh or salt water, whether manmade or naturally occurring, such as for example creeks, rivers, lakes, canals, inland seas, oceans, seas, bays and gulfs, such as the Gulf of Mexico. Also, such terms would include drilling activities on, or beneath, highways, parkways, railroads, buildings, bridges, airports, and interstates, such as beneath Interstate 75 in the United States, beneath an airport runway, beneath a railroad track in a proposed alignment. As used herein, unless specified otherwise the term “drilling rig” is to be given its broadest possible meaning and would include hydraulic auger bore machines, hydraulic pipe jacking frames, tunnel bore machines (TBM), Direct Pipe jacking frames (trademarked), horizontal directional drilling machines (HDD), equal pressure balance machines (EPBM), rotary drills, shaft drills, and foundation drills and other equipment known in the art.

As used herein, unless specified otherwise “backing”, “weld backing”, “weld back strip”, “backing strip”, and similar terms are used in their broadest sense and would include a piece of metal that is placed on the backside of a weld joint to prevent the molten metal from dripping through the open root (burn through). This may help to ensure that 100% of the base metal's thickness is fused by the weld (full penetration). The backing must be thick enough to withstand the heat of the root pass as it is burned in. Local welding codes supersede to determine metal thickness and material.

As used herein, unless specified otherwise “sliplining”, “pipe rehabilitation”, and similar terms are used in their broadest sense and is completed by installing a smaller, “carrier pipe” into a larger “host pipe”, grouting the annular space between the two pipes, and sealing the ends. In this instance, the interlocking tubular pipe serves as the carrier pipe. Sliplining is used to repair leaks or restore structural stability to an existing pipeline. Sliplining may be used to continuously restore a pipe section or point repair specific locations as needed.

### SUMMARY OF THE INVENTION

There is a need for a tube that provides lower risk to tunneling operations, having the ability to reduce tunnel diameter or dimensions, may be a structural standalone product, and interlocks for a sealed encasement. There is a need for a tubular system and method that provides the benefits of jacked in-place tubular materials with the benefits of tunnel liner plate installations, to advance a borehole, compared to conventional drilling technologies, methods, and techniques which do not provide associated benefits of both. There is a need for an interlocking tubular system and method that provides the ability to create a defined deflection between tubes during installation, to advance a borehole along arcuate sections. The present inventions, among other things, solve these and other needs by providing the articles of manufacture, devices, methods, and processes taught herein.

There is a need for a second section part that collapses, passes within and through a previously installed tube, then expands to its final radius or dimensional shape so the first section may be installed, and complete the whole interlocking tube.

In one embodiment, a tube may have two ends with corresponding profiles, such as being CNC machine profiled, on the inner side of one end and the outer side of the other end, creating, one male and one female end. These interlocking ends may include profiles that are smooth, round, square, angled edges, or any combination thereof, for the purpose of interlocking two interconnecting tubular ends. The interlocking ends may be mirrored profiles of each other. CNC quality tolerances may take precedence in tolerance and fit, as different shapes and diameters require specific tolerance allowances. The profiled ends may be smooth and have beveled edges for full circumferential and longitudinal welding in lieu of interlocking profile, edges, or any combination of beveling in addition to having interlocking profiles. Additionally, there may be grooves, single or multiple, circumferentially routed into the profiled ends to install a rubber gasket or any type of gasket to provide watertight seal between interlocking male and female ends.

In another embodiment, the tube may have a longitudinally oriented section that has been removed, such that a portion of the tube may collapse and slide within and through the previously installed tube. The collapsed tube section advances along the borehole to its final position such that the two connecting ends of consecutive tubes match as the mirrored profiles align. An apparatus may expand the forward most tube section outward as the interlocking male end engages against the inner side of the previously installed tube's interlocking female end. There may be an apparatus that functions to expand the collapsed section to its intended radius or dimension and maintain tolerances. The longitudinally oriented section that had been removed may be installed once the collapsible section of the tube has been expanded to a correct radius or dimensional shape. If welding is employed, backing strips, beveled edges, and other preparatory measures shall be incorporated per welding code.

In a further embodiment, a tube may have a first section removed, prior to collapsing a second section of that tube. The first section removed is specific to that tube and will be reused to form one single interlocking tubular piece as described further in the embodiments in accordance with the present invention.

A second tube may be provided that may have two profiled ends, one end being a male end having no overhanging weld backing strip, and the opposite end being a female end. The female end may have an overhanging weld backing strip, of unspecified width. The overhanging weld backing strip may be fully circumferential, and may provide enough weld backing strip width, such that as a male end of a newly installed tube is installed within and against the weld backing strip of second tube's female end, such that the inner diameter of the female end matches closely to the male end's inner diameter once expanded against the inner wall of the overhanging weld backing strip. Accordingly, a root pass weld per local welding code may be achieved. Therefore, the second tube, may not be required to have two precisely profiled ends, because once two tubes have been installed as described within, welding may fully join two tubes together to form an interlocked joint, whether or not corresponding profiled ends are present on the consecutive tubes. Thus, in some instances, the ability to provide weld backing strips may negate the requirement for precisely machined profiled male and female ends.

In one aspect, the female end includes an overhanging weld backing strip, but the male end does not include such a strip. A collapsible second section of a subsequent tube may include a longitudinally installed weld backing strip, running along both sides of the bottom portion of the second section, running from the end of the second section's female end's overhanging weld backing strip to just before the male end, such that the male end is at least as long as the female end in length. Therefore, as a male end of the subsequent tube may be installed within and against the female end of the previous, proximal tube. The weld backing strip may be provided for code welds longitudinally and circumferentially. The two ends of consecutive tubes may ultimately butt against one another.

During installation, the collapsible second section of the tube may advance along the borehole to its final position such that the two ends of the consecutive tubes butt against one another and do not overlap in any manner. An expansion apparatus may expand the expandable second section outward as the male end engages against the inner side of the overhanging weld backing strip of the previously installed tube's female end. There may be provided an apparatus that functions to expand the collapsed section to its intended radius or dimension and maintain tolerances. The first section, which had been previously removed from the collapsible second section, may be installed once second section has been expanded to a correct radius or dimensional shape.

In an additional embodiment, a tube may have a first section removed, prior to collapsing the remaining second section of the tube. The first section may have an overhanging weld backing strip on its female end. The first section may be reused to form one single interlocking tubular piece upon installation in a borehole.

In yet another embodiment, two adjacent tubes may include overlapping profiled ends. A first of the tubes may include a profile on a radially inner side of a first end, and a second of the tubes may include a profile on a radially outer side of a second end. The overlapping profiled ends may form a connection between the adjacent tubes. The connection may include a longitudinal gap extending in a direction of the borehole path. This gap may be adapted to receive a shim. The shim may be shaped so as to cause an angle of deflection between longitudinal axes of the adjacent tubes once installed. Thus, the shim may provide interlocking tubulars the ability to change orientation along an arcuate section either longitudinally, latitudinally, or both in accordance with the present invention. For example, the shim may allow for the creation of a predetermined deflection between two tubes along a curved alignment, double curved radius, U-shaped, Y-shaped, arcuate shaped, or any shape conceivable to tunneling in the future.

In one aspect, connection may include a radial gap between the male and female profiles. The radial gap may be at least partially defined by one of the male and female ends including in its profile a wall with an angle with respect to a radially corresponding wall of the other of the male and female ends. This angle defining the gap within the connection may be adapted to provide a series of interlocking tubes the ability to change orientation along an arcuate section longitudinally, latitudinally, or both in accordance with the present invention.

In another aspect, the profile of the male and female ends may include curved walls. For example, one of the male and female profiles may include a concave wall and a radially corresponding portion of the other of the male and female profiles may include a convex wall. Thus, the male and female profiles may form a ball and socket joint therebetween.

In a further embodiment, an interlocking tube for use in encasement of a borehole is provided. The tube includes a first section extending in a longitudinal direction, the first section comprising a first sidewall defining a minor arc extending in a circumferential direction along a first arclength less than 180 degrees. The tube further includes a second section extending in the longitudinal direction, the second section comprising a second sidewall defining a major arc extending in the circumferential direction along a second arclength greater than 180 degrees. The first section and the second section are separable for insertion into the borehole. Upon insertion into the borehole, the first section is adapted for connection to the second section to form an assembled interlocking tube with an assembled sidewall extending 360 degrees in the circumferential direction.

In one aspect, the assembled interlocking tube comprises a first end with a first connector adapted to connect the assembled interlocking tube with a first adjacent interlocking tube on a proximal side of the borehole from the assembled interlocking tube. The first connector may be a non-threaded connector. The assembled interlocking tube may comprise a second end with a second connector adapted to connect the assembled interlocking tube with a second adjacent interlocking tube on a distal side of the borehole from the assembled interlocking tube.

In another aspect, the first section and the second section do not overlap one another in the assembled interlocking tube.

A further embodiment of an interlocking tube for use in encasement of a borehole comprises a first section extending in a longitudinal direction, the first section comprising a first sidewall defining a first arc extending in a circumferential direction. The tube also includes a second section extending in the longitudinal direction, the second section comprising a second sidewall defining a second arc extending in the circumferential direction. The first section and the second section are separable for insertion into the borehole. Upon insertion into the borehole, the first section is adapted for connection to the second section to form an assembled interlocking tube with an assembled sidewall including the first sidewall and the second sidewall, the assembled sidewall extending 360 degrees in the circumferential direction, wherein the first sidewall and the second sidewall do not overlap one another along the circumferential direction in the assembled sidewall.

In one aspect, the first arc extends in the circumferential direction an arclength less than 180 degrees. In another aspect, the second arc extends in the circumferential direction an arclength greater than 180 degrees.

The assembled interlocking tube may include a first end with a first connection and a second end with a second connection, each of the first connection and second connection being adapted to connect the assembled interlocking tube to an adjacent interlocking tube. The first connection and the second connection may be non-threaded connections.

In an additional embodiment, a system of interlocking tubes for use in encasement of a borehole comprises a first tube including a first end with a first non-threaded connector. The system additionally includes a second tube comprising, in an unassembled configuration, a first section extending in a longitudinal direction, the first section comprising a first sidewall defining a first arc with arclength less than 360 degrees extending in a circumferential direction, and a second section extending in the longitudinal direction, the second section comprising a second sidewall defining a second arc with arclength less than 360 degrees extending in the circumferential direction. The first section and the second section are separable for insertion through an interior of the first tube. Upon insertion through the first tube, the first section is adapted for connection to the second section along at least one longitudinal seam to form an assembled configuration of the second tube. The assembled configuration of the second tube comprises a second end with a second non-threaded connector adapted to engage the first non-threaded connector to form a connection between the first tube to the second tube. Additionally, the connection includes a gap in the longitudinal direction and is adapted to allow angular deflection of the second tube from the first tube with respect to the longitudinal direction.

In one aspect, an outer diameter of the first tube is equal to an outer diameter of the assembled configuration of the second tube. The first section may define an arclength of greater than 180 degrees and is adapted for radial contraction from the outer diameter of the assembled configuration to a smaller contracted diameter for insertion through the interior of the first tube, and the first section is further adapted for re-expansion to the outer diameter of the assembled configuration upon forming the assembled configuration.

The connection may comprise the first non-threaded connector radially outside the second non-threaded connector. The second non-threaded connector may be adapted to be expanded into an inner diameter of the first non-threaded connector to form the connection. In another aspect, the first connector and the second connector may comprise corresponding longitudinally extending walls, and wherein at least one of the longitudinally extending walls includes an angle of deflection with respect to the longitudinal axis such that, within the connection, at least a portion of the longitudinally extending wall of one of the first connector and the second connector is neither parallel nor perpendicular to a radially corresponding portion of the longitudinally extending wall of the other of the first connector and the second connector. The angle of deflection may be between 1 and 10 degrees with respect to the longitudinal axis.

In a further aspect, one of the first connector and the second connector comprises a convex wall in the longitudinal direction and the other of the first connector and the second connector comprises a concave wall, such that within the connector, the convex wall and the concave wall are adapted for angular movement therebetween, allowing for relative rotation between the first tube and the second tube.

A shim may be provided, said shim extending partially around the circumference of the connection within the gap, thereby holding a relative angular position between the first tube and the second tube. The shim may be crescent-shaped.

### BRIEF DESCRIPTION OF THE DRAWINGS

FIG. 1 is a schematic view of an assembled tube in accordance with one embodiment of the present invention;

FIG. 2 is a schematic view of the tubular of FIG. 1 with first section separated from a second section;

FIG. 3 is a schematic of the tubes installed in a tunneling system using a tunnel bore machine (TBM);

FIGS. 4A and 4B show a single tube using a connecting strip;

FIGS. 5A-5F show a series of schematic views diagraming a method of install a distal tube within and through a previously installed proximal tube;

FIGS. 6A-6C illustrate a cross sectional view of a distal tube being installed and connected to a proximal tube;

FIG. 7 is an enlarged cross-sectional view of first embodiment of a connection between adjacent tubes;

FIG. 8 is an exploded view of adjacent tubes including the connection of FIG. 7;

FIGS. 9A-9B illustrate enlarged cross-sectional views of a second embodiment of a connection between adjacent tubes;

FIGS. 10A-10C illustrate enlarged cross-sectional views of a third embodiment of a connection between adjacent tubes;

FIGS. 11A-11C illustrate enlarged cross-sectional views of a fourth embodiment of a connection between adjacent tubes;

FIGS. 12A-12B illustrate enlarged cross-sectional views of a fifth embodiment of a connection between adjacent tubes; and

FIGS. 13A-13B illustrate a system of tubes and installation thereof in a vertical drilling environment.

### DETAILED DESCRIPTION OF THE INVENTION

The present invention relates to a system of interlocking tubes. This system may be used in a tunneling system to advance a borehole. For example, after a first tubular has been installed in the borehole, a second tubular may be inserted through the first tubular in a collapsed position, such as sliding within and through the previously installed tubular. This insertion of the second tubular may be accomplished in a section nearest the bottomhole of the borehole. The installed tubulars, being made up of a first section and second section, maintain their structural properties following installation and each tubular may be stationary once installed in accordance with the present invention.

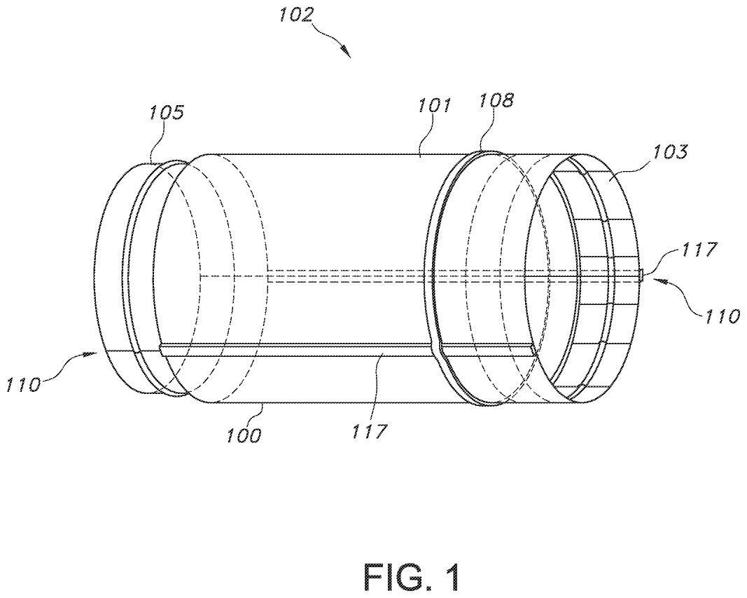

Turning to FIG. 1 there is shown an interlocking tube 102. The interlocking tube 102 may comprise a first section 100 and a second section 101. Each of the first section 100 and the second section 101 may extend in a longitudinal direction along a longitudinal axis of the interlocking tube 102. A seam 110 may connect the first section 100 to the second section 101. This seam 110 may be a longitudinal seam and may extend in a longitudinal direction along the length of the interlocking tube 102. As shown in FIG. 1, two longitudinal seams 110 may be provided for connecting each side of the first section 100 and the second section 101 together.

The interlocking tube 102 may further include a first end 103 and a second end 105, the first and second ends being adapted for connecting to adjacent interlocking tubes, such as within a borehole. In addition, one or more seals 108, such as an outer diameter sealing ring, which may be waterproof, may be provided for sealing between an outside of the interlocking tube 102 and the borehole in which the tube is installed.

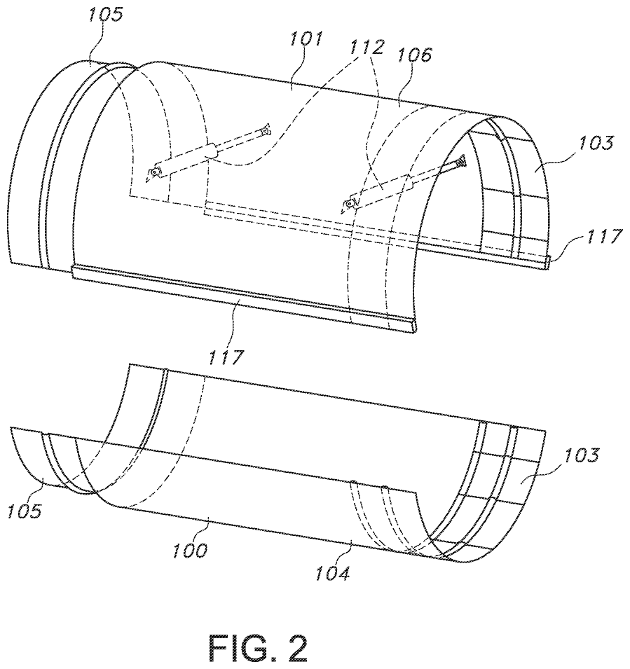

As shown in FIG. 2, the first section 100 and the second section 101 may be separable from one another, such as for insertion and/or installation in a borehole as described herein. For example, the first section 100 and the second section 101 may be separable along the one or more longitudinal seams 110. One or more reinforcing strips 117, such as a weld backing strip, may be provided for connecting the first section 100 and the second section 101. During the installation process, as described herein, the reinforcing strips 117 may be used to physically connect the first section 100 to the second section 101, such as by welding, and more specifically, by internal electrode welding.

The first section 100 may be defined by a first sidewall 104, and the second section 101 may be defined by a second sidewall 106. The first sidewall 104 may define a first arclength, which may be less than 180 degrees. Thus, the first sidewall 104 may define a minor arc. The second sidewall 106 may define a second arclength, which may be greater than 180 degrees. Thus, the second sidewall 106 may define a minor arc.

In an unassembled configuration, such as that illustrated in FIG. 2, the first end 103 of the assembled interlocking tube 102 (as illustrated in FIG. 1) may be composed of first end portions 103a, 103b, which may be located at the first ends of the first and second sidewalls 104, 106, respectively. Similarly, in the unassembled configuration, the second end 105 may be composed of second end portions 105a, 105b, which may be located at the second ends of the first and second sidewalls 104, 106, respectively.

In one aspect, the second sidewall 106 may be expandable and contractable in a radial direction, such as for installation in the borehole, as is described herein. For example, in an assembled configuration, the second sidewall 106 may have a first diameter equal to a diameter of the assembled interlocking tube 102. In an unassembled configuration, the second sidewall 106 may be adapted for contraction to a second diameter, smaller than the first diameter. Thus, the second section 101 may be contracted for insertion through a tubular formation (e.g. a borehole or a previously installed interlocking tube) having a diameter equal to (and in some instances smaller than) a final diameter of the interlocking tube 102 made of the second section 101 being installed.

One or more tube size modifiers or expansion and contraction devices 112 may be provided for expanding and contracting the second section between an assembled diameter and a smaller installation diameter. The expansion and contraction device 112 may comprise a mechanical, hydraulic, electronic, or other mechanism (e.g. a hydraulic cylinder). The expansion and contraction device 112 may be connected at one or more points within the second section 101, and thus may pull and/or push the second sidewall in order to expand and contract the diameter of the second section 101.

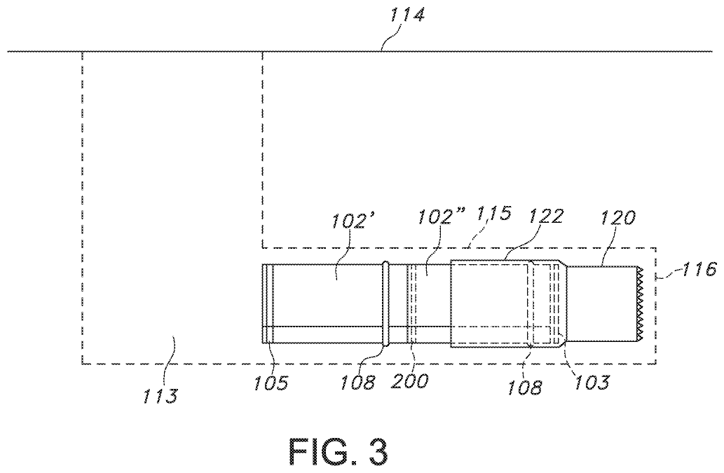

Turning to FIG. 3, a series of installed interlocking tubes 102, including first interlocking tube 102′ and second interlocking tube 102″, is illustrated within a borehole 115. A tunnel bore machine (TBM) 120 may be used to advance the borehole 115. The TBM may include a TBM tail 122 that may at least partially envelopes the forwardmost tube 102″. In one aspect, the TBM tail 122 may envelop at least a portion of the next proximal interlocking tube 102′. The seal 108 may provide a leakproof seal between the outer diameter of the tube 102 and the inner side of the TBM tail 122. As the TBM 120 advances the borehole 115 further along the bottomhole 116, the TBM tail 122 may envelope enough of a proximal tube 102′ to install the subsequent tube 102″ while protecting the proximal tube 102′ and maintaining a leakproof seal. As a distal tube 102″ is attached to a proximal tube 102′, a connection 200 may be made between the tubes, such as between a first end 103 of a proximal tube 102′ and a second end 105 of a distal tube 102″.

The series of interlocking tubes may be facilitated from a launch pit 113, from which new interlocking tubes may be carried within and through previously installed interlocking tubes 102 toward the bottomhole 116 for installation as the borehole 115 is advanced and secured. The series of interlocking tubes 102, having been connected and joined at respective ends of tubes, create a wholly and structural tunnel. The series of previously installed interlocking tubes 102 are shown being installed in place in respect to a top of ground 114 orientation, similarly found in tunnel and microtunnel installations, this orientation may be of any slope without departing from the spirit of the invention.

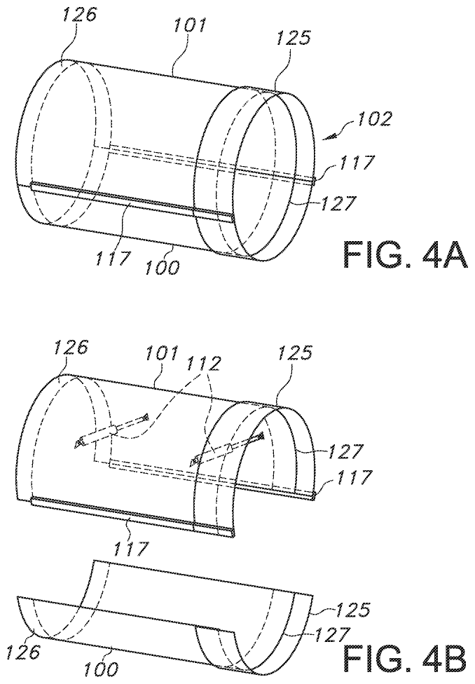

FIGS. 4A and 4B illustrate at least one manner of connecting consecutive tubes within a borehole. For example, a tube 102 may be provided with a male end 126 and a female end 127. The female end 127 of a proximal tube 102′ may be adapted for receiving a male end 126 of a distal tube 102″. In one aspect, the female end 127 may be provided with a connecting strip 125, which may at least partially overhand the female end 127. The connecting strip 125 may comprise a weld backing strip. Upon insertion of the male end 126 of a distal tube 102″ into the female end 127 of a proximal tube 102′, the connecting strip 125 may be used to weld or otherwise attach the distal tube 102″ to the proximal tube 102′. As illustrated in FIG. 4B, the first section 100 and the second section 101 of the tube 102 may each include a portion of the respective male and female ends 126, 127 of the tube.

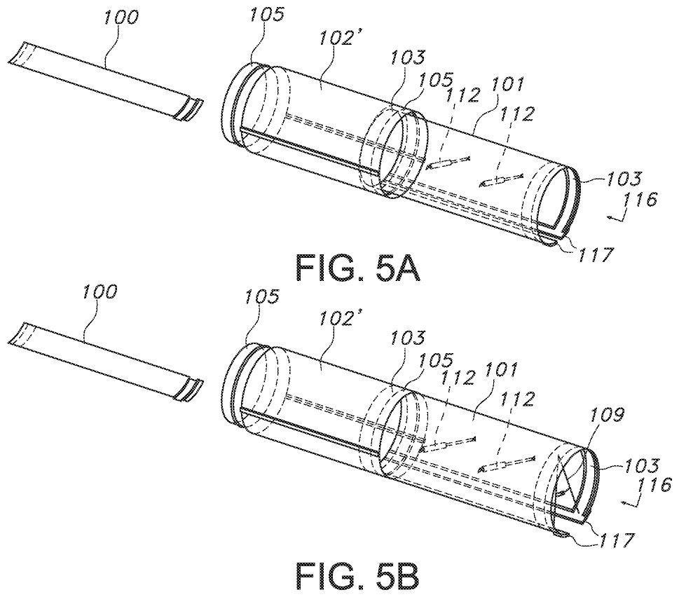

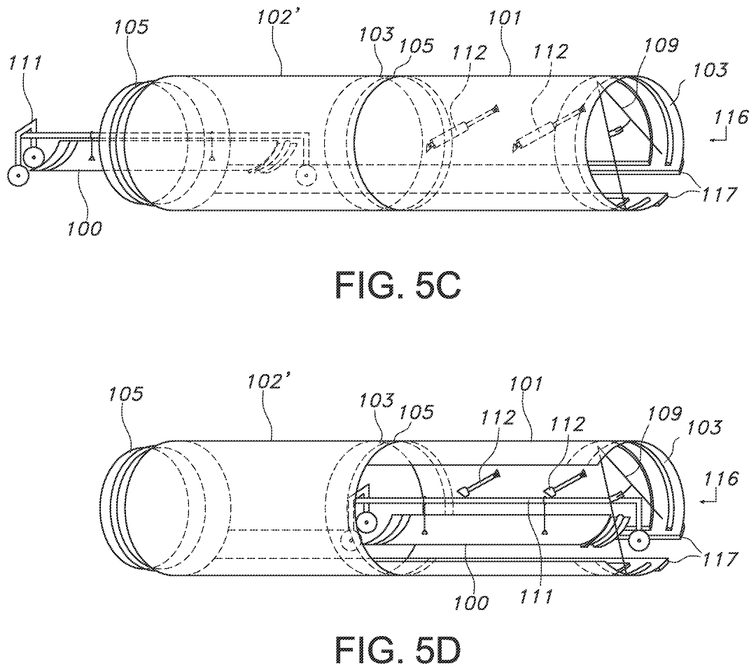

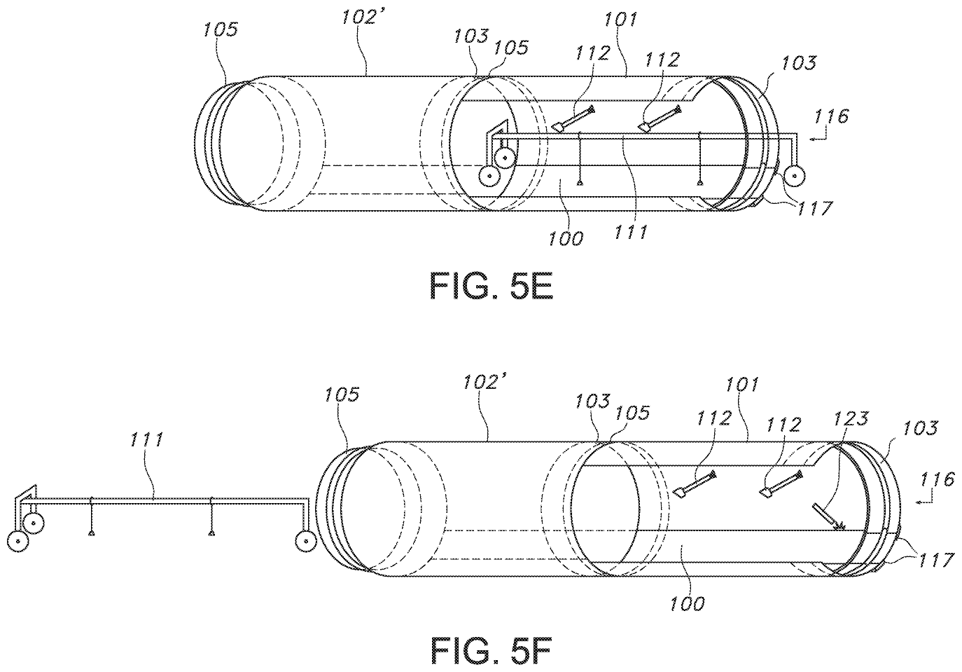

Turning to FIGS. 5A-5F, there are shown a series of diagrams of the installation process to install new distal tube 102″ within and through previously set proximal tubes 102′. In one aspect, a radius gage 109 or other radius measuring tool may be used as shown and described.

Turning to FIG. 5A, a previously installed, proximal interlocking tube 102′ is illustrated, having a first end 103 and a second end 105. Through this proximal tube 102′, a second section 101, in a collapsed configuration, may be passed. The collapsed configuration of the second section 101 may be maintained by contraction of the expansion and contraction device 112 during transport of the second section 101 through the proximal tube 102′.

As shown in FIG. 5B, the second section 101 may be progressed to a point within the borehole such that the second end 105 of the second section 101 is aligned with the first end 103 of the proximal tube 102′. The expansion and contraction device 112 may be actuated to expand the second section 101 until the second end 105 of the second section 101 engages the first end 103 of the proximal tube 102′. In one aspect, the second end 105 of the second section 101 may comprise a profile that is a mirror image of a profile of the first end 103 of the proximal tube 102′. In another aspect, the second end 105 of the second section 101 may comprise a male profile adapted to engage a female profile of the first end 103 of the proximal tube 102′.

Once the second section 101 is expanded, the diameter of the second section 101 may be the same as the diameter of the proximal tube 102′. Expansion of the second section 101 may be measured or controlled by the radius gage 109. The radius gage 109 may include a biasing device, such as a spring for biasing the diameter of the second section 101 radially inward or radially outward. In another aspect, the radius gage 109 may comprise a stop, such as a set screw, a limited tongue and groove, a spring within a groove including a stop wall, or other means of limiting the expansion and contraction of the second section 101. The stop may allow the tube to be expanded to a predetermined diameter, rather than expanding to engage a sidewall of the borehole, a profiled ridge, edge, or other feature of the borehole.

Turning to FIGS. 5C-5D, once the second section 101 has been expanded, the first section 100 may be transferred through the proximal tube 102′. The first section 100 may be inserted through the proximal tube 102′, such as by a carrier 111 and brought into longitudinal alignment with the second section 101. As shown in FIGS. 5E-5F, the first section 100 may then be attached to the second section 101, such as by way of reinforcing strips 117, thus creating a fully formed distal tube 102″. The carrier 111 may then be removed for use in a similar installation of a subsequent interlocking tube.

The proximal tube 102′ and the distal tube 102″ may be connected by forming a connection 200 therebetween. The connection 200 may comprise a connecting strip 125 and/or male and female corresponding profiles as described herein. The male and female corresponding profiles may be non-threaded in nature.

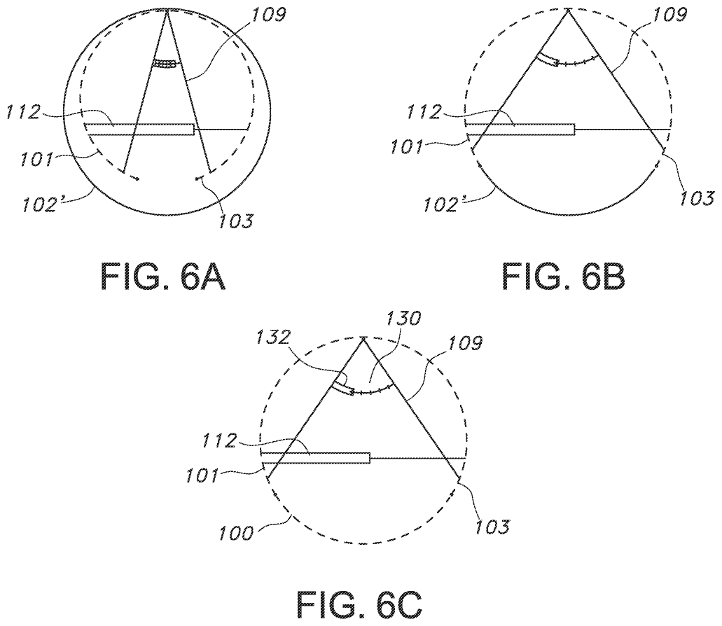

FIGS. 6A-6C show a profile view of a collapsible and expandable second section 101 and first section 100 which may be used to create an assembled configuration of a distal interlocking tube 102″, connected to a proximal tube 102′, from the downhole perspective within the borehole. As can be seen in FIG. 6A, the expansion and contraction device 112 may be used to reduce the diameter of the second section 101 to an installation diameter for insertion through the proximal tube 102′. This installation diameter of second section 101 is smaller than a diameter of the previously installed proximal tube 102′.

As illustrated in FIG. 6B, once the second section 101 is positioned in the appropriate longitudinal position with respect to the proximal tube 102′, the expansion and contraction device 112 may be actuated to expand the second section 101 to the assembled diameter, which may be equal to the final diameter of the proximal tube 102′ and the assembled, distal tube 102″. FIG. 6C illustrates the installation of the first section 100, which may be joined to the second section 101 to form the distal tube 102″ as described herein.

The radius gage 109, which may be installed at a location adjacent the first end 103 of the second section 101, may include a biasing member 130, such as a spring or telescoping rod. The biasing member 130 may slide with respect to a track or guide 132. In use, one of the biasing member 130 and the track or guide 132 may include a stop, such as a set screw or a wall beyond which the biasing member may no longer travel or expand. This stop may limit diameter to which the second section 101 may expand, such as to a predetermined assembled diameter.

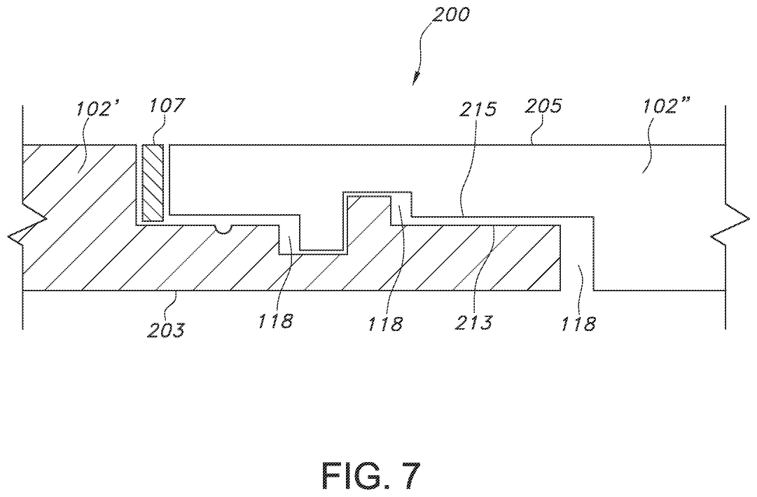

Turning to FIG. 7 there is shown an enlarged schematic view of connection 200 between a previously installed proximal tube 102′ and a subsequently installed distal tube 102″. The proximal tube 102′ may include a first connector 203, which may be positioned on a first end 103 of the proximal tube 102′. The distal tube 102″ may include a second connector 205, which may be positioned on a second end 105 of the distal tube 102″. As illustrated, the second connector 205 is radially inward from the first connector 203.

In profile, the first connector 203 may include a first connector wall 213, and the second connector 205 may include a second connector wall 215. Each of the first connector wall 213 and the second connector wall 215 may extend in a generally longitudinal direction. The first connector wall 213 may face radially inward, and the second connector wall 215 may face radially outward within the connection. Thus, as illustrated, the first connector 203 may be a female connector and the second connector 205 may be a male connector, as the second connector 205 is adapted to be received radially within the first connector 203. The first connector wall 213 and the second connector wall 215 may comprise complementary profiles that may include one or more extensions and receivers for fitting together and inhibiting relative longitudinal movement between the proximal tube 102′ and the distal tube 102″.

In one aspect, the connection 200 may include one or more gaps 118 therein. The gap 118 may extend in a longitudinal direction between at least a portion of the first connector 203 and the second connector 205. The gap 118 may be 1%, 3%, 10%, or greater than an overall length of the connection 200. In some instances, a plurality of gaps 118 may be provided, such as between profile features of the first connector wall 213 and the second connector wall 215. Thus, the complementary profiles of the first connector wall 213 and the second connector wall 215 may be adapted to allow a longitudinal space therebetween, such as within the connection 200. The one or more gaps 118 may allow for a defined amount of angular deflection between the proximal tube 102′ and the distal tube 102″, once the connection 200 is formed therebetween. The shape or spacing of the gaps 118 may be adapted to provide for angular deflection in a horizontal direction, a vertical direction, or both.

In a further aspect, a shim 107 may be provided for use in association with the connection 200. The shim 107 may be adapted for placement within a gap 118, thus forcing a relative angular position between the proximal tube 102′ and the distal tube 102″. The shim 107 may be of a shape adapted to hold a specific predetermined relative angular position between the proximal tube 102′ and the distal tube 102″. For example, the shim 107 may comprise a predetermined shape, which may extend at least partially in a circumferential direction around the annular connection 200. In one aspect, the shim 107 may extend around the entire circumference of the connection 200, while in other aspects, the shim 107 may extend only partially around the circumference of the connection 200. The shim 107 may vary in shape and/or thickness along its profile.

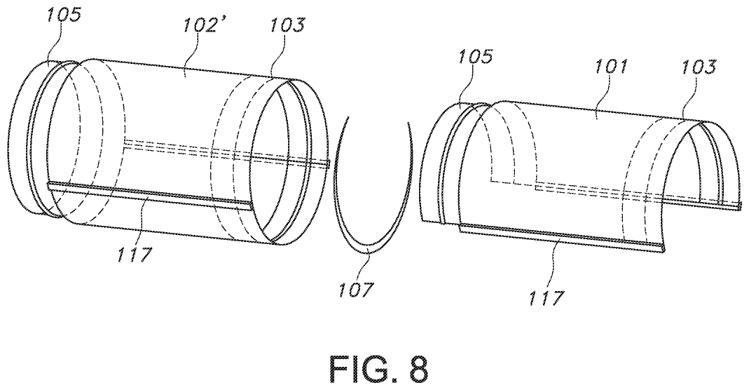

For example, as illustrated in FIG. 8, the shim 107 may be crescent shaped. Such a configuration may allow for the shim to hold the proximal tube 102′ and the distal tube 102″ farther apart at a portion of the circumference of the connection 200 in which the shim 107 is thickest, while allowing the proximal tube 102′ and the distal tube 102″ to be closer together along portions of the circumference of the connection 200 in which the shim 107 is thinner or not present within the gap 118, thus maintaining the angular deflection between consecutive tubes. The application of a shim 107 may allow for curved tunnels or microtunnels, horizontal directional drilling, and U-shaped, Y-shaped, and heel and toe drilling operations. As further illustrated in FIG. 8, the shim may be installed during the process of installation of the distal tube 102″, such as at the time of expanding the second section 101 to engage the first end 103 of the proximal tube 102′. Accordingly, the shim 107 may be captured within the connection 200 at the time of forming said connection 200.

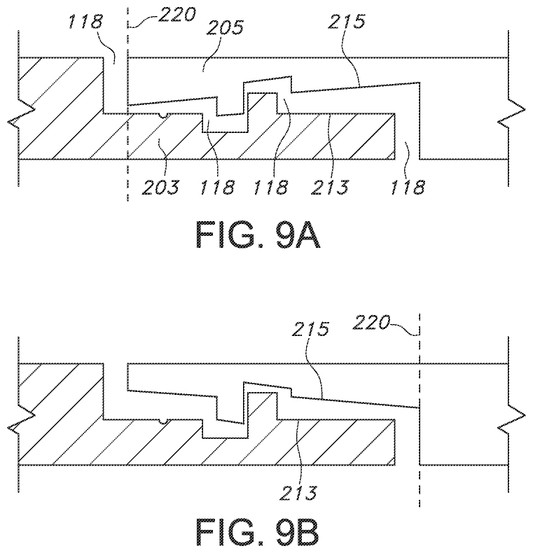

Turning to FIGS. 9A-9B, a further embodiment of connection 200 between a previously installed proximal tube 102′ and a subsequently installed distal tube 102″ is illustrated. At least one of the first connector wall 213 or the second connector wall 215 may include profile that trends radially inward (i.e. at an incline) or radially outward (i.e. at a decline) in a direction from a proximal end to a distal end with respect to the longitudinal axis. This incline or decline may be linear. The incline or decline may define an angle of deflection of 1, 3, 5, or 10 degrees or greater. This incline or decline may allow for deflection within the connection 200, and therefore relative angular deflection between the proximal tube 102′ and distal tube 102″.

A deflection plane 220 may exist within the connection 200, which may define a plane beyond which the profile of a first or second connector wall 213, 215 may extend from a proximal to a distal direction in a linear incline or decline profile with respect to the longitudinal axis. In FIG. 9A, the deflection plane 220 is located on a proximal end of the second connector wall 215, such that the profile of the second connector wall 215 extends, from the proximal to the distal direction, at an incline with respect to the longitudinal axis. As illustrated in FIG. 9B, the deflection plane 220 may be located at a distal end of the second connector wall 215, such that the second connector wall 215 includes a profile defining a decline from its proximal end to its distal end. In one aspect, the inclined or declined profile of a connector wall may be constant around a circumference of the annular connection 200.

In another aspect, the incline or decline of the profile of the connector wall may change around a circumference of the annular connection 200. For example, at a first position on the circumference of the connection 200, the profile of the connection may be as illustrated in FIG. 9A. As the profile transitions in a circumferential direction around the connection 200, the profile may gradually and continuously shift from the profile of FIG. 9B, such as at a position 180 degrees apart from the location of the profile of FIG. 9A on the circumference of connection 200. Thus, the deflection plane 220 may shift from a proximal end of the second connector wall 215 to a distal end of the second connector wall 215. This transition of the profile of the connection may further facilitate relative angular deflection between adjacent tubes.

While FIGS. 9A-9B illustrate an incline associated with only the second connector wall 215, with the first connector wall 213 extending generally in the longitudinal direction, it is understood that either or both of the connector walls 213, 215 may include an incline or a decline as described. It is further understood that while either or both of the connector walls 213, 215 may include a linear incline or a decline, said connector wall(s) may also include projections and/or recesses adapted to engage the corresponding connector wall along that inclined or declined profile.

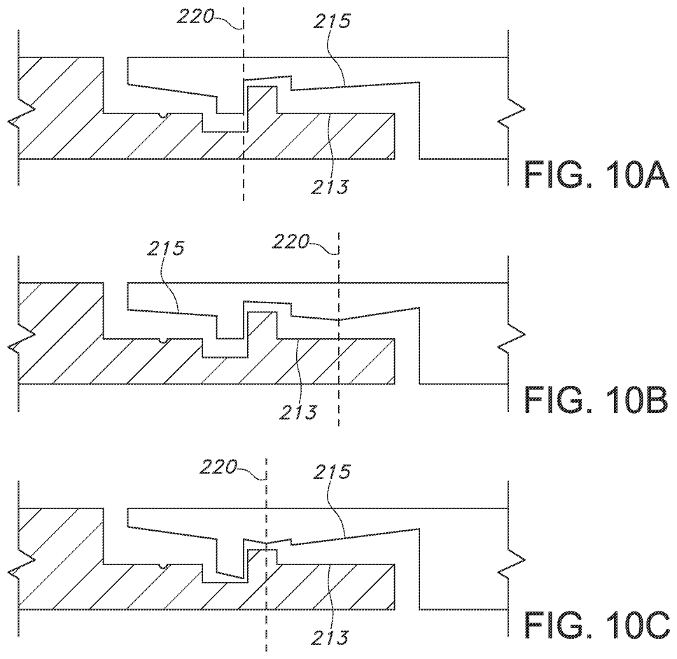

FIGS. 10A-10C illustrate that the deflection plane 200 may be located at a position other than at a proximal or distal end of the first or second connecting wall 213, 215. For example, the deflection plane 220 may be located at a position between a proximal end of the second connector wall 215 and the distal end of the second connector wall 215. FIG. 10A illustrates the deflection plane 220 at an intermediate point along the second connector wall 215, but closer to a proximal end. On a proximal side of the deflection plane 220, the second connector wall 215 includes a profile defining a linear decline with respect to the longitudinal axis, while on the distal side of the deflection plane 220, the second connector wall 215 includes a profile defining a linear incline with respect to the longitudinal axis. In FIG. 10B, the deflection plane 220 is located at an intermediate point along the second connector wall 215, but closer to a distal end. And in FIG. 10C, the deflection plane 220 is located at a midpoint along the second connector wall 215. In each instance, the incline or decline of the connector wall may define an angle of deflection of 1, 3, 5, or 10 degrees or greater.

As with FIGS. 9A-9B, the embodiment of any of FIGS. 10A-10C may remain constant around the circumference of annular connection 200, or the profile may transition from one to another of the illustrated profiles at different points around the circumference of annular connection 200. For example, the profile of connection 200 may appear as that of FIG. 10A at a first point on the circumference of the connection 200, then the deflection plane 220 may gradually and continuously transition to the location illustrated in FIG. 10C at an adjacent position along the circumference of the connection 200, and then further gradually and continuously transition to the location illustrated in FIG. 10B at a further position along the circumference.

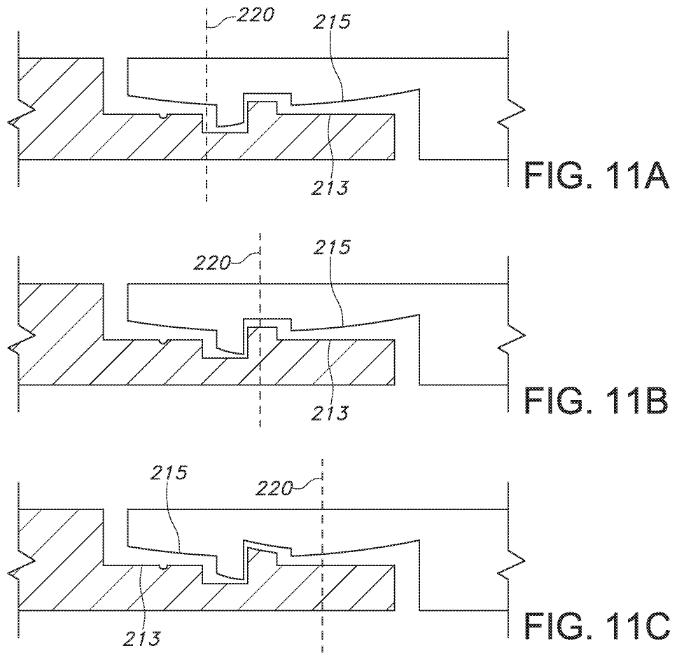

Turning to FIGS. 11A-11C, the profile of a given connector wall around a deflection plane 220 may be non-linear from a proximal to a distal end. FIG. 11A illustrates a deflection plane 220 closer to a proximal end of second connector wall 215. The profile of that second connector wall 215 on a proximal side of the deflection plane 220 may define a non-linear decline, such as a parabolic or other curvilinear trend radially outward in a direction from the proximal end to the distal end. On a distal side of the deflection plane 220, the profile may define a non-linear incline, such as a parabolic or other curvilinear trend radially inward in a direction from the proximal end to the distal end. FIG. 11B illustrates the deflection plane 220 located at a midpoint of the second connector wall 215, while FIG. 11C illustrates the deflection plane 220 located closer to a distal end of the second connector wall 215.

As with the previous embodiments, the embodiment of any of FIGS. 11A-11C may remain constant around the circumference of annular connection 200, or the profile may transition from one to another of the illustrated profiles at different points around the circumference of annular connection 200. For example, the profile of connection 200 may appear as that of FIG. 11A at a first point on the circumference of the connection 200, then the deflection plane 220 may gradually and continuously transition to the location illustrated in FIG. 11B at an adjacent position along the circumference of the connection 200, and then further gradually and continuously transition to the location illustrated in FIG. 11C at a further position along the circumference.

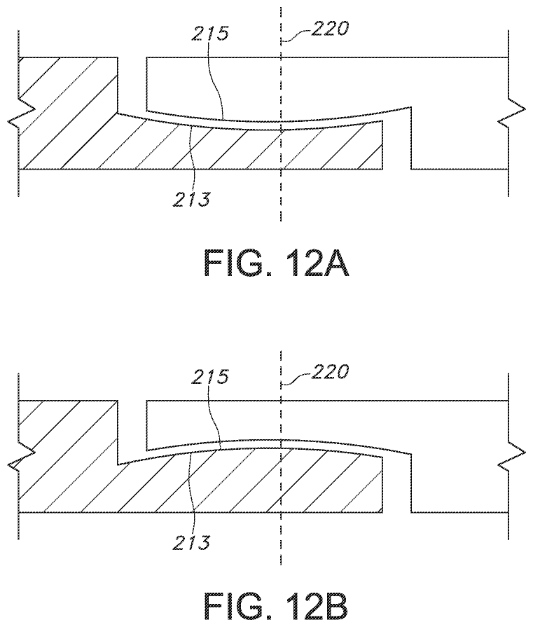

In another embodiment, as shown in FIGS. 12A-12B, the connection 200 may include both first connector wall 213 and second connector wall 215 defining corresponding curvilinear profiles. In each of these embodiments, no projections or recesses are illustrated within the profile of the first and second connector walls 213, 215, though such projections and recesses may be present, as described in other embodiments. The deflection plane 220 may define a point at which the profile of a connector wall transitions from an incline curve to a decline curve. For example, FIG. 12A shows that first connector wall 213 may comprise a concave profile, while second connector wall 215 may comprise a convex profile. Similarly, FIG. 12B shows that first connector wall 213 may comprise a convex profile, while second connector wall 215 may comprise a concave profile. Thus, the coordination of first and second connector walls 213, 215 may form a ball and socket joint therebetween. In one aspect, a radius of curvature of the concave and convex profile of the first and second connector walls 213, 215 may be half of the diameter of the annular connection 200.

A ball and socket connection, such as that of FIGS. 12A-12B, may provide an interlocking joint due to the curvature of the radius being of sufficient size to prevent or limit relative longitudinal movement between adjacent tubes. The end joint may be machined from a thicker piece of steel casing than the tube itself to be able to cut a radius and provide the required strength for the designed tunnel. Once second connector 205 of the second section 101 is opened against the first connector 203 of a proximal tube 102′, welding along a seam between the second connector 205 of the first section 101 and the first connector 203 of the proximal tube 102′ may produce a pool of molten weld melt into the first connector 203 of the proximal tube 102′, such as because of a v-groove weld preparation. Therefore, a socket formed by the first connector 203 of the proximal tube 102′ may act as the weld back strip. Hence, a ball and socket, especially in the context of a metal pipe, may provide substantial pull-apart resistance compared to a bell and spigot on a concrete pipe.

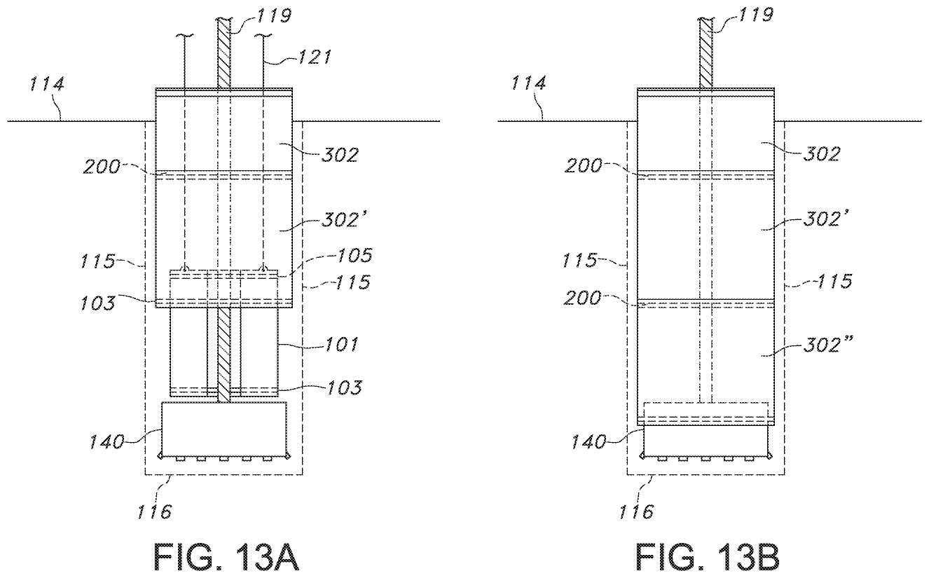

The interlocking tubes 102 of the present invention are not limited to horizontal boring operations. For example, as illustrated in FIGS. 13A-13B, installation of consecutive tubes 102 is shown in a vertical drilling operation. As can be seen, a vertical drilling shaft 119 is used to drive a vertical drill bit 140 in order to progress a borehole 115. The vertical drill bit 140 may be applied at the bottomhole 116, thus progressing a length of the borehole 115 downward.

As shown in FIG. 13A, a first interlocking tube 302 has been installed near the level of the ground 114. A second interlocking tube 302′ is installed and has been connected to the first interlocking tube 302, such as by way of a connection 200 described herein. A second section 101 of third interlocking tube 302″ may be inserted through the previously-installed tubes, such as by way of vertical rigging 121. As described herein, the second end 105 of the second section 101 may be aligned with the first end 103 of the previously-installed second tube 302′. A first section 101 may be introduced through the first and second tube 301, 301′, to be joined with the first section 101. As shown in FIG. 13B, the third tube 302″ may be formed from the first and second sections 100, 101, and the assembled third tube 302″ may be connected to the second tube 302′, such as by way of a connection 200. Thus the tubing lining the vertical borehole 115 may be further extended, much as with the horizontal examples illustrated herein.

While the invention has been described with reference to specific examples, it will be understood that numerous variations, modifications and additional embodiments are possible, and all such variations, modifications, and embodiments are to be regarded as being within the spirit and scope of the invention. Also, the drawings, while illustrating the inventive concepts, are not to scale, and should not be limited to any particular sizes or dimensions. Accordingly, it is intended that the present disclosure not be limited to the described embodiments, but that it has the full scope defined by the language of the following claims, and equivalents thereof.

1. An interlocking tube for use in encasement of a borehole comprising:
a first section extending in a longitudinal direction, the first section comprising a first sidewall defining a minor arc extending in a circumferential direction along a first arclength less than 180 degrees;
a second section extending in the longitudinal direction, the second section comprising a second sidewall defining a major arc extending in the circumferential direction along a second arclength greater than 180 degrees;
wherein the first section and the second section are separable for insertion into the borehole; and
wherein upon insertion into the borehole, the first section is adapted for connection to the second section to form an assembled interlocking tube with an assembled sidewall extending 360 degrees in the circumferential direction.

2. The interlocking tube of claim 1, wherein the assembled interlocking tube comprises a first end with a first connector adapted to connect the assembled interlocking tube with a first adjacent interlocking tube on a proximal side of the borehole from the assembled interlocking tube.

3. The interlocking tube of claim 2, wherein the first connector is a non-threaded connector.

4. The interlocking tube of claim 2, wherein the assembled interlocking tube comprises a second end with a second connector adapted to connect the assembled interlocking tube with a second adjacent interlocking tube on a distal side of the borehole from the assembled interlocking tube.

5. The interlocking tube of claim 1, wherein the first section and the second section do not overlap one another in the assembled interlocking tube.

6. An interlocking tube for use in encasement of a borehole comprising:
a first section extending in a longitudinal direction, the first section comprising a first sidewall defining a first arc extending in a circumferential direction;
a second section extending in the longitudinal direction, the second section comprising a second sidewall defining a second arc extending in the circumferential direction;
wherein the first section and the second section are separable for insertion into the borehole; and
wherein upon insertion into the borehole, the first section is adapted for connection to the second section to form an assembled interlocking tube with an assembled sidewall including the first sidewall and the second sidewall, the assembled sidewall extending 360 degrees in the circumferential direction, wherein the first sidewall and the second sidewall do not overlap one another along the circumferential direction in the assembled sidewall.

7. The interlocking tube of claim 6, wherein the first arc extends in the circumferential direction an arclength less than 180 degrees.

8. The interlocking tube of claim 7, wherein the second arc extends in the circumferential direction an arclength greater than 180 degrees.

9. The interlocking tube of claim 6, wherein the assembled interlocking tube includes a first end with a first connection and a second end with a second connection, each of the first connection and second connection being adapted to connect the assembled interlocking tube to an adjacent interlocking tube.

10. The interlocking tube of claim 9, wherein the first connection and the second connection are non-threaded connections.

11. A system of interlocking tubes for use in encasement of a borehole comprising:
a first tube including a first end with a first non-threaded connector;
a second tube comprising, in an unassembled configuration,
a first section extending in a longitudinal direction, the first section comprising a first sidewall defining a first arc with arclength less than 360 degrees extending in a circumferential direction; and
a second section extending in the longitudinal direction, the second section comprising a second sidewall defining a second arc with arclength less than 360 degrees extending in the circumferential direction;
wherein the first section and the second section are separable for insertion through an interior of the first tube;
wherein upon insertion through the first tube, the first section is adapted for connection to the second section along at least one longitudinal seam to form an assembled configuration of the second tube; and
wherein the assembled configuration of the second tube comprises a second end with a second non-threaded connector adapted to engage the first non-threaded connector to form a connection between the first tube to the second tube;
wherein the connection includes a gap in the longitudinal direction and is adapted to allow angular deflection of the second tube from the first tube with respect to the longitudinal direction.

12. The system of claim 11, wherein an outer diameter of the first tube is equal to an outer diameter of the assembled configuration of the second tube.

13. The system of claim 12, wherein the first section defines an arclength of greater than 180 degrees and is adapted for radial contraction from the outer diameter of the assembled configuration to a smaller contracted diameter for insertion through the interior of the first tube, and the first section is further adapted for re-expansion to the outer diameter of the assembled configuration upon forming the assembled configuration.

14. The system of claim 11, wherein connection comprises the first non-threaded connector radially outside the second non-threaded connector.

15. The system of claim 11, wherein the second non-threaded connector is adapted to be expanded into an inner diameter of the first non-threaded connector to form the connection.

16. The system of claim 11, wherein the first connector and the second connector comprise corresponding connector walls, said connector walls extending in the longitudinal direction, and wherein at least one of the longitudinally extending walls includes an angle of deflection with respect to the longitudinal axis such that, within the connection, at least a portion of the connector wall of one of the first connector and the second connector is neither parallel nor perpendicular to a radially corresponding portion of the connector wall of the other of the first connector and the second connector.

17. The system of claim 16, wherein the angle of deflection is between 1 and 10 degrees with respect to the longitudinal axis.

18. The system of claim 11, wherein one of the first connector and the second connector comprises a convex connector wall extending in the longitudinal direction and the other of the first connector and the second connector comprises a concave connector wall extending in the longitudinal direction, such that within the connector, the convex connector wall and the concave connector wall are adapted for angular movement therebetween, allowing for relative rotation between the first tube and the second tube.

19. The system of claim 11, further comprising a shim extending partially around the circumference of the connection within the gap, thereby holding a relative angular position between the first tube and the second tube.

20. The system of claim 19, wherein the shim is crescent-shaped.
